(19) United States
(12) Patent Application Publication
(10) Pub. No.: US 2004/0216695 A1
(43) Pub. Date: Nov. 4, 2004

(54) High strength elastic tie cord construction and horse tie training aid provided thereby

(76) Inventor: Darren Stovall, Norco, CA (US)

Correspondence Address: MARK D. OLSON, OLSON & OLSON, 2400 S.W. 4th Avenue, Portland, OR, 97201, US

(21) Appl. No.: 10/767,927

(22) Filed: Jan. 29, 2004

Related U.S. Application Data
(60) Provisional application No. 60/444,332, filed on Jan. 30, 2003.

(51) Int. Cl. B68B 1/00; A01K 27/00

(52) U.S. Cl. 119/769; 54/71

(57) ABSTRACT

A high strength, longitudinally elongated elastic tie cord is provided as an integral, single strand, cast body formed from a selected thermosetting castable polyurethane having cast-in terminal end connector fittings arranged to assure against breakage and separation of the end connectors from the elastic body of the tie cord, whereby to provide an elastic horse tie training aid device arranged to elastically and resistively yield to stretching and jerking forces applied thereagainst by a struggling horse being trained to accept being tied, and to endure all such forces without damage or breaking under the full force of a horse struggling thereagainst until its inherent instinct to free itself from restraint has been overcome and broken by the training exercise, and thereby provide a safe and humane training aid for training horses to accept being tied while substantially eliminating injury to the animal during its training.

This application claims benefit under 35 U.S.C. 119(e) of the priority filing date of U.S. Provisional application Serial No. 60/444,332, filed 30 Jan. 2003, incorporated herein in its entirety by reference.

### BACKGROUND OF THE INVENTION

This invention relates generally to tethers, horse ties and elastic tie downs, and more particularly to an elastic tie cord construction which provides a horse tie training aid device for safely and humanely securing a horse to a fixed structure whereby to train the animal to accept being tied and to break the animal of undesirable and harmful escape behaviors when placed under such tied restraint.

As is well known by those familiar with the raising and training of horses, horses are born with their natural, essentially wild instincts substantially intact, and therefore it is recognized that the domestication of horses requires training to overcome the horse's innate, inborn natural instincts. This is true when training these animals to accept wearing halters, saddles and other pieces of equipment required by man, as well as in the training horse to accept being led and being tied. It is this last aspect to which the present invention is primarily directed.

In this regard, a horse does not normally understand or accept the concept of being tied to a fixed structure. The horse's natural instinct is to escape from such restraint. All too often in this endeavor to free itself of its restraint, the animal is injured in the process.

As can well be understood, when a horse is tied to a fixed structure by a rope or similar tie cord, the pulling, jerks and shocks of a struggling 200 pound to 2000 pound horse against an unyielding tie restraint often results in broken necks, strained necks, and frequently in the animal entangling itself in its tie cord which can result in strangulation and broken bones. When one further considers that a horse will exert up to three times its own body weight in force applied against the horse tie during its efforts to extricate itself from its restraint, one can easily appreciate the great potential for injury that exists for the animal's rather fragile head and neck structure.

However, as discussed before, the horse's natural instinct is to fight for its freedom. And when a horse pulls against an unyielding horse tie, its response to that unyielding securement is to pull and jerk and struggle even harder and more frantically thereagainst.

Applicant however has discovered that a horse's inherent instinct to fight its tied restraint can be confused and overcome by the provision of a suitable elastic horse tie cord that effectively pulls back on the horse with a substantially equal tension as the horse is exerting thereagainst. Moreover, an elastic horse tie utilizing the tie cord of this invention, by virtue of its unique, elastic nature also effectively protects against all of the aforementioned injuries experienced by horses during this training process.

### SUMMARY OF THE INVENTION

In its basic concept this invention provides an extremely high strength, longitudinally elongated, single strand, elastic tie cord formed as a single cast body member from a selected thermosetting castable polyurethane having a hardness in the range of between 65 A to 97 A durometer, the tie cord having predetermined overall length and cross sectional dimensions and opposite, cast-in terminal end connector fittings to prevent breakage and separation of the end connectors from the elastic cord of the tie cord.

It is by virtue of the foregoing basic concept that the principal objective of this invention is achieved; namely, the provision of an elastic tie cord construction that will elastically and resistively yield to stretching force applied thereagainst such as that supplied by a struggling horse connected to one of its ends, the opposite end being connected to a fixed structure, and also endure without damage or breaking under the full force of a horse struggling thereagainst to free itself from its tether to the fixed structure by the elastic tie cord, whereby to provide a safe and humane horse tie training aid for training horses to accept being tied and substantially eliminate injury to the animal during training.

Another object of this invention is the provision of an elastic tie cord of the class described which has complete and substantially permanent memory retention, does not fray, rot, retain moisture and is not significantly affected by sunlight or wide temperature variations.

Another object of this invention is the provision of an elastic horse tie training aid which significantly reduces head, neck, back and leg injuries resulting from the animal's struggles during the training process.

A further object of this invention is the provision of an elastic tie cord of the class described which may if desired be alternatively utilized as an elastic tie down cord for vehicles and other heavy loads.

A still further object and advantage of this invention is the provision of an elastic tie cord which is of simplified construction for economical manufacture.

The foregoing and other objects and advantages of the present invention will appear from the following detailed description, taken in connection with the accompanying drawings of a preferred embodiment.

### BRIEF DESCRIPTION OF THE DRAWINGS

FIG. 1 is a foreshortened top plan view of a horse tie training aid embodying features of this invention.

FIG. 2 is a foreshortened, exploded view of the horse tie training aid of FIG. 1.

FIG. 3 is a foreshortened side elevation of the horse tie training aid of FIG. 1 as viewed from the top in FIG. 1.

FIG. 4 is a foreshortened side elevation of the horse tie training aid of FIG. 3 as viewed from the opposite side in FIG. 3.

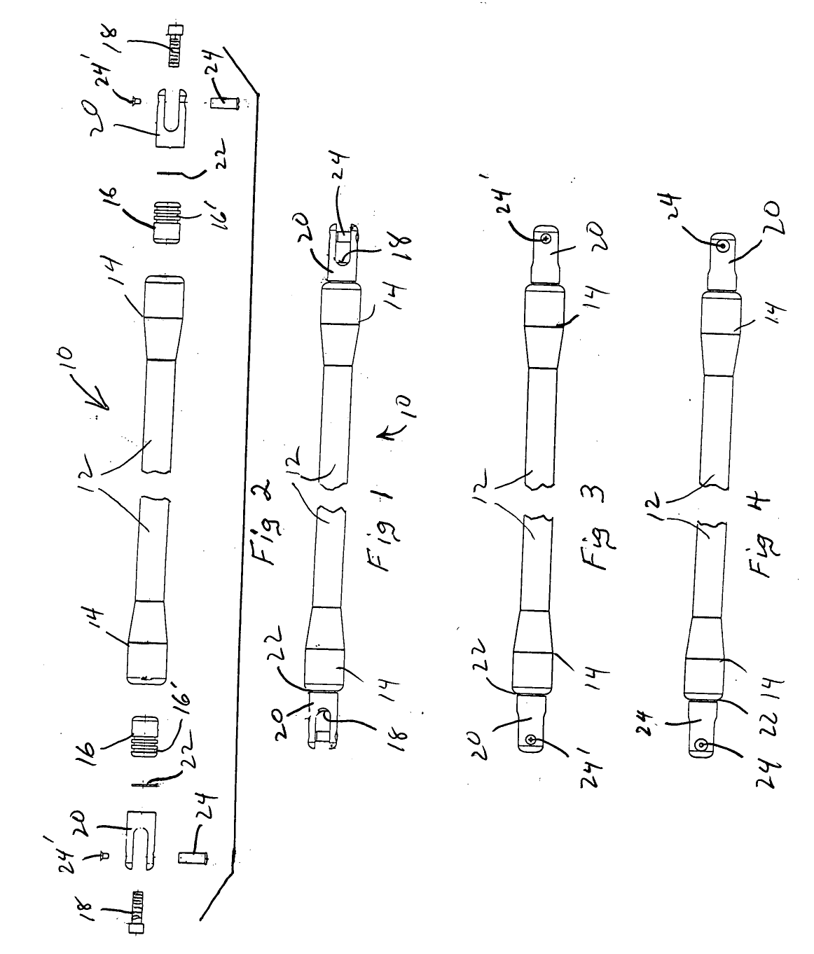

### DESCRIPTION OF THE PREFERRED EMBODIMENT

As will be apparent from viewing the drawings, an elastic horse tie utilizing the tie cord construction of this invention provides an elongated elastic tether body member 10 comprising an elongate center section 12 terminating, in the present embodiment, in opposite, longitudinal end sections 14 configured to securely mount end anchor fitting insert members 16 molded therein during the casting of the tether. In the embodiment illustrated these tie cord end sections 14 have an enlarged cross sectional dimension. As will be apparent to those skilled in the art, the embedded end fitting insert members 16 each include an axially extending, threaded central bore (not shown) configured to threadedly receive a cap screw 18 inserted through an enlarged, non-threaded central bore (not shown) of a cord end connector member 20, illustrated herein as swivel fixtures 20, as is apparent in the exploded view of FIG. 2 of the drawings.

A washer 22 may be interposed between the swivel fixture 20 and the terminal end of the anchor insert 16 to reduce friction therebetween and facilitate easy, non-binding swiveling of the swivel fixture 20 mounted thusly on the opposite terminal ends of the elongated tether 10. The swivel fixture 20 in turn mounts a shoulder screw assembly 24, 24′ in conventional manner to provide an attachment mount to which any selected fastener member (not shown) may be releasably connected for securement of the cord end to a desired structure or other mount. Alternatively, the connector members 20 may be integral with the associated anchor end fittings 16, as well as configured as needed or desired to include an integral fastener member or other coupler arrangement for connection to a desired structure or other mount.

In its preferred form, a horse tie training aid device constructed in accordance with the elastic tie cord teachings herein may include a center section 12 having a circular cross section approximately 1 inch in diameter and with the overall length of the elastic tie body 12, 14 being selected as desired for various sizes, weights and ages of horses, the stage and type of training, and the surrounding training area. Typically the elastic horse tie may be provided in various overall lengths such as 30 inches, 48 inches, 60 inches, and 72 inches, the trainer selecting a desired one given the particular horse training situation, course and training exercise.

Both unique to and critical to the elastic horse tie construction of this invention is the material composition of the elastic tie cord member 10. In this regard, the elastic tie cord body of this invention is formed as a single strand cast member formed of a predetermined, selected thermosetting castable polyurethane material having a hardness in the range of between 65-A to 97-A durometer. Such castable polyurethane materials include all toluene diisocyanate (TBI), Diphenylmethane diiocyanate (MDI), para-phenylene diisocyanate (PPDI) and polycapralactone material in both polyether and polyester bases.

As will be apparent from FIG. 2 of the drawings, the embedded end anchor fittings 16 are preferably provided with a plurality of annular grooves 16′ about their exterior surfaces in order that, during the manufacture of the horse tie, with the end anchor fittings placed into the mold prior to introduction of the polyurethane material during casting, as the elastic tie cord body is cast, the polyurethane material will flow inbetween and engage within the grooves and thereby form a stronger, more positive, substantially integral securement of the fitting embedded within the polyurethane material. Preferably, a suitable bonding agent is applied to the exterior, grooved surface of the end anchor fittings prior to casting, so that the resulting securement of the embedded end anchor fittings is in fact stronger than the breaking strength of the polyurethane material itself.

In this manner the elastic tie cord of this invention is provided with end connector fittings that avoid the heretofore known failure problems associated with clamp on, crimp on and pass-through end connector fitting mounting arrangements associated with bungee-type and other previously available elastic cords and tie-downs. Furthermore, the breaking strength of a polyurethane horse tie constructed in accordance with the present invention and having an approximately 1 inch diameter far exceeds the greatest pull and jerk tension that can be produced by the largest and most powerful of fully struggling horse, thereby virtually entirely eliminating any chance of breakage of the horse tie, either through tearing of the elastic body material or by separation of the end connectors therefrom, during use, with consequent injury to the animal.

With the foregoing structure and construction of the elastic tie cord of this invention thus described, the operation of the elastic tie cord as a horse tie training aid device is as follows:

An elastic tie cord according to this invention is provided as an elongate horse tie having a desired length and predetermined cross sectional thickness dimension and is connected, through a desired fastener coupler (not shown) engaging the connector member at one of its ends, to a fixed, stationary support structure. The opposite terminal end of the horse tie is connected through a desired fastener coupler (not shown) engaging the opposite end connector member to the proper mount on the horse's halter, as is understood by those skilled in the art of handling horses.

When the untrained horse realizes it is now restrained against free movement away from the supporting structure it instinctively endeavors to flee from its restraint. As is well known by those familiar with horses and as can be readily recognized even by those unfamiliar with horses, these animals exert tremendous effort and extreme force against the horse tie during this training process as has been described hereinbefore.

However, when the horse realizes that its pulls and jerks are met with substantially equal and opposite, yielding and elastically resisting tension supplied by the elastic horse tie cord training aid, the horse's inherent instinct to continue intensifying its fight against its restraint is confused and is overcome much more quickly than otherwise occurs when an unyielding restraint tie is used. Moreover, since the restraint provided by the tie cord of this invention is a yielding restraint that substantially counters the various intensity of the pulling and jerking force supplied by the horse as it struggles thereagainst, the potential for shock-type injuries to the neck, head and spine of the animal commonly experienced when unyielding ties are employed in training unbroken animals, it is virtually completely eliminated. Also, since the tie cord of this invention comprises a construction that provides an elastic cord break strength and end attachment fittings mounting arrangement that far exceeds the greatest forces that even the largest horses can apply, the elastic horse tie training aid device provided by the elastic tie cord of this invention eliminates the potential of injury to the animal resulting from breakage of the cord structure during training as well.

From the foregoing it will be apparent to those skilled in the art that various changes other than those previously described may be made in the size, shape, type, number and arrangement of parts described hereinbefore without departing from the spirit of this invention and the scope of the appended claims.

Having thus described my invention and a preferred manner in which it may be used, I claim:

1. An elastic tie cord comprising:
a) a longitudinally elongated, substantially unitary elastic cord member cast as a single, substantially solid body member having predetermined overall longitudinal length and cross sectional thickness dimensions, said body member formed of a selected thermosetting castable polyurethane material having a selected hardness in the range of between 65-A to 97-A durometer, said elongated elastic cord member terminating in opposite longitudinal terminal ends, and
b) embedded end anchor fittings cast into said body member during casting of the elastic cord member, one anchor fitting embedded into each opposite terminal longitudinal end of the elastic body member, each said embedded anchor fittings mounting a cord end connector member arranged for connection to a desired mount to which the associated end of the elastic cord member is to be secured.

2. The elastic tie cord of claim 1 wherein at least one of said cord end connector members is a swivel member arranged to permit relative rotation between the associated terminal end of the elastic cord member and a mount to which the associated end of the cord member is secured.

3. The elastic tie cord of claim 1 wherein said selected polyurethane material is selected from the group consisting of all toluene biisocyanate (TBI), Diphenylemethane diiocyanate (MDI), para-phenylene diisocyanate (PPDI) and polycapralactone material in both polyether and polyester bases.

4. A horse tie training aid device for safely and humanely training horses to accept being tied to a fixed support while eliminating injuries commonly encountered by a struggling horse during training to tie, the horse tie training aid device comprising, an elastic horse tie cord member comprising:
a) a longitudinally elongated, substantially unitary elastic horse tie cord cast as a single, substantially solid body member having a predetermined overall longitudinal length and predetermined cross sectional thickness dimension and formed of a selected thermosetting castable polyurethane material having a selected hardness in the range of between 65-A to 97-A durometer, said elastic horse tie cord terminating in opposite longitudinal terminal ends, and
b) embedded end anchor fittings cast into said body member during casting of the elastic horse tie cord, one anchor fitting embedded into each opposite terminal longitudinal end of the body member, each said embedded anchor fitting mounting a cord end connector member, one said connector member arranged for connection to a fixed support mount, the opposite cord end connector member arranged for connection to a mount on a halter worn by a horse to be trained.

5. The horse tie training aid device of claim 4 wherein at least one of said cord end connector members is a swivel member arranged to permit relative rotation between the elastic horse tie cord and its associated mount.

6. The horse tie training aid of claim 1 wherein said selected polyurethane material is selected from the group consisting of all toluene diisocyanate (TBI), Diphenylmethane diiocyanate (MDI), para-phenylene diisocyanate (PPDI) and polycapralactone material in both polyether and polyester bases.
